(19) United States
(12) Patent Application Publication
(10) Pub. No.: US 2002/0100673 A1
(43) Pub. Date: Aug. 1, 2002

(54) Quite button assembly

(76) Inventors: David Stephen Bulin, Greentown, IN (US); Brian Alan Cotterman, Sharpsville, IN (US); Sara J. Baus, Kokomo, IN (US); David J. Clute, Cicero, IN (US); Kamal S. Thakur, Noblesville, IN (US)

Correspondence Address: JIMMY L. FUNKE, DELPHI TECHNOLOGIES, INC., Legal Staff Mail Code A-107, P.O. Box 9005, Kokomo, IN, 46904-9005, US

(21) Appl. No.: 09/773,141

(22) Filed: Feb. 1, 2001

(51) Int. Cl. H01H 21/04

(52) U.S. Cl. 200/339

(57) ABSTRACT

A push button assembly 10 is provided, including a button body 12 and a pivot element 14. At least one noise reducing element 20 covers a portion of the pivot element 14 and thereby reduces the generation of noise generated by the pivot element 14 as the push button assembly 10 rotates.

### TECHNICAL FIELD

The present invention relates generally to a button assembly with reduced noise characteristics and more particularly to a button assembly with a reduced tendency to squeak during operation.

### BACKGROUND OF THE INVENTION

Electronic devices and controls have become widely prevalent in almost every aspect of life. Their design and purpose can run the gamut of simple operation, audio control, environmental control, and a host of other known uses. Often, the interfaces of these designs use simple controls, such as push buttons, to provide a simple and well known method of activating functions. Commonly, such push buttons are hard plastic injection molded items. Their surfaces may be decorated with words or symbols to indicate function. Although such push buttons may be formed in an almost infinite number of shapes and configurations, one standard category of push button design includes hinged and hard rocker push buttons.

Hinged and hard rocker button designs typically function by pivoting the button body about a pivotal element. Often this is accomplished by positioning the cylindrical pivot element within a pocket allowing the push button to rotate about the cylindrical element. During activation of such designs, however, the rotation of the pivot element within the pocket can generate friction between the pivot element and the pocket and thereby cause noise generation. Often this noise generation takes the form of high pitched noise commonly referred to as squeaking. This noise generation is often highly undesirable. The production of squeaking or squeaks or other undesirable noises during button operation may result in a loss of customer satisfaction. The generation of such noises, although typically not affecting proper operation of the push button, may result in a perception of poor quality. It would, therefore, be highly desirable to have a push button design that would reduce noise generation during operation and thereby improve perceptions of quality and customer satisfaction.

### SUMMARY OF THE INVENTION

It is therefore an object of the present invention to provide a push button assembly with reduced unwanted noise generation characteristics.

In accordance with the object of the present invention, a push button assembly is provided. The push button assembly includes a button body, including a pivot element. A noise reducing element covers a portion of the pivot element, thereby reducing the generation of noise due to friction generated by the pivot element during operation.

Other objects and features of the present invention will become apparent when viewed in light of the detailed description of the preferred embodiment when taken in conjunction with the attached drawings and appended claims.

### BRIEF DESCRIPTION OF THE DRAWINGS

FIG. 1 is an illustration of an embodiment of an unassembled push button assembly in accordance with the present invention;

FIG. 2 is a cross-section of an embodiment of a push button assembly as shown in FIG. 1, the push button assembly shown assembled and mounted for operation; and

FIG. 3 is a detail of a noise reducing element for use with a push button assembly in accordance with the present invention.

### DESCRIPTION OF THE PREFERRED EMBODIMENT(s)

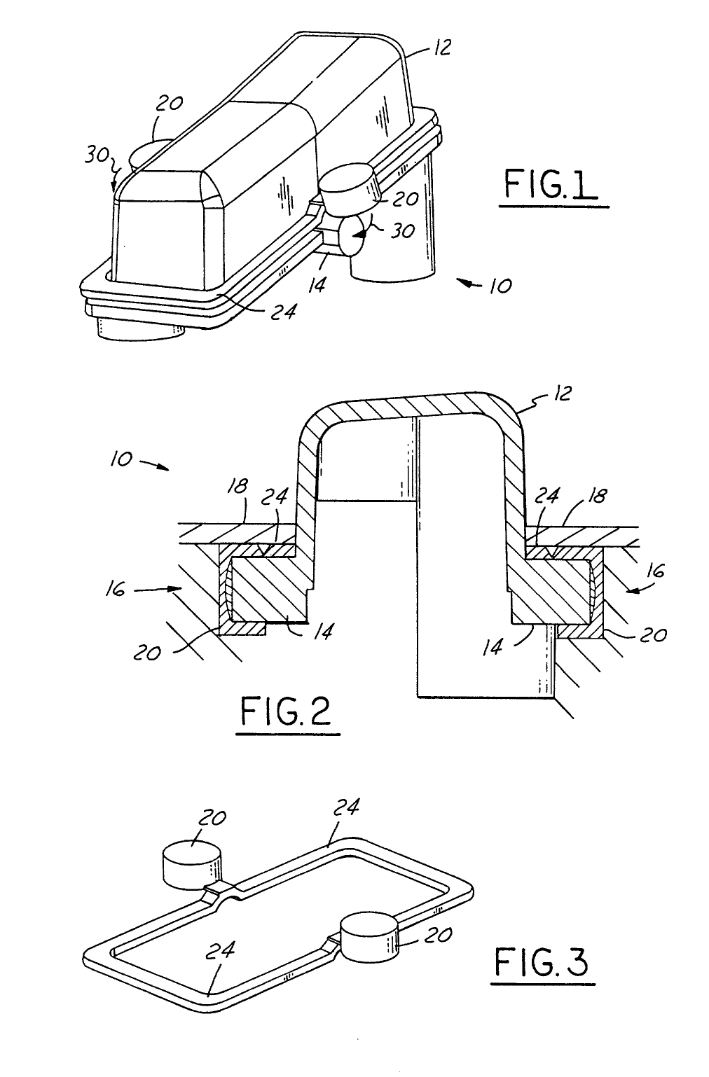

Referring now to FIG. 1, which is an illustration of a push button assembly in accordance with the present invention. Push button assembly 10 includes button body 12, including pivot element 14. Although push button assembly 10 has been illustrated as a traditional rocker-style push button, it should be understood that a wide variety of rocker and hinged push button shapes and designs are contemplated by the present invention. Both rocker-style and hinged-style push buttons utilize a pivot element 14 to allow button movement. In addition, although the pivot element 14 has a general cylindrical shape, it should be understood that a wide variety of pivot element designs are known and used in the prior art and contemplated by this invention.

Referring now to FIG. 2, which is a cross-sectional illustration of a push button assembly 10 in accordance with the present invention. The push button assembly 10 is commonly mounted such that the pivot element 14 is positioned within a pocket 16. A cap 18 is often positioned over the pocket 16 to hold the push button assembly 10 in position. By positioning the pivot element 14 within the pocket 16, the push button assembly 10 is allowed to pivot and thereby affect is operation. Although push button assembly 10 has been described with a pivot element 14 residing in a pocket 16, it should be understood that in alternate embodiments, the pocket 16 may be formed as part of the button body 12 and the pivot element 14 may be mounted externally.

The push button assembly 10 further includes a noise reducing element 20 covering a portion of the pivot element 14. The noise reducing element 20 is positioned in-between a pivot element 14 and the pocket 16, and thereby reduces the generation of noise caused by friction between the pivot element 14 and the pocket 16 during rotation. Although the noise reducing element 20 may be formed from a variety of materials, in one embodiment the noise reducing element 20 is formed of rubber. In alternate embodiments, the noise reducing element 20 may be formed from a variety of polymers or elastomers.

Often, push button designs use back lighting in order to illuminate words or figures illustrated on the surface of the button body 12. With such backlit designs, it may be desirable to prevent the escape of light from around the edges of the push button assembly 10. The present invention further contemplates that the noise reducing element 20 may be formed in combination with a gasket 24 to add the further functionality to the button assembly 10 in which the escape of light from around the sides of the button assembly 10 is reduced. An illustration of the gasket 24 and noise reducing element(s) 20 is shown in FIG. 3. In the shown embodiment, the noise reducing elements 20 may be folded down (as illustrated by the arrows 30 in FIG. 1) in order to cover a portion of the pivot element 14. One additional advantage of the embodiment illustrated in FIG. 3 is that it may be useful on present push button designs and configurations. The ability to use presently manufactured push button designs in combination with the noise reducing element 20 in order to practice the present invention, further accentuates the simplicity and versatility of the present invention.

While particular embodiments of the invention have been shown and described, numerous variations and alternative embodiments will occur to those skilled in the art. Accordingly, it is intended that the invention be limited only in terms of the appended claims.

1. A push button assembly comprising:
a button body;
a pivot element; and
at least one noise reducing element covering a portion of said pivot element.

2. The push button assembly as described in claim 1 further comprising:
a gasket running along the base of said button body and reducing the emission of light from the sides of said button body.

3. The push button assembly as described in claim 2 wherein said gasket and said noise reducing element are formed as a single element.

4. The push button assembly as described in claim 1 wherein said at least one noise reducing element is a polymer.

5. A push button assembly as described in claim 1 wherein said at least one noise reducing element is comprised of rubber.

6. A push button assembly as described in claim 1 wherein said pivot element is a cylinder.

7. A push button assembly as described in claim 1 further comprising:
a pocket;
said pivot element rotating within said pocket during operation of the push button assembly;
wherein said noise reducing element is positioned between said pivot element and said pocket such that the noise generated by the rotation of said pivot element within said pocket is reduced.

8. A push button assembly as described in claim 1 for use with a rocker-style push button.

9. A push button assembly as described in claim 1 for use with a hinge-style push button.

10. A push button assembly comprising:
a button body including a pivot element, said pivot element rotating within a pocket during operation of the push button assembly; and
at least one noise reducing element positioned between said pivot element and said pocket such that noise generated by the rotation of said pivot element within said pocket is reduced.

11. The push button assembly as described in claim 10 further comprising:
a gasket running along the base of said button body and reducing the emission of light from the sides of said button body.

12. The push button assembly as described in claim 11 wherein said gasket and said noise reducing element are formed as a single element.

13. The push button assembly as described in claim 11 wherein said at least one noise reducing element is a polymer.

14. A push button assembly as described in claim 11 wherein said at least one noise reducing element is comprised of rubber.

15. A push button assembly as described in claim 11 wherein said pivot element is a cylinder.

16. An apparatus for reducing noise in pushbuttons including a pivot element comprising:
at least one noise reducing element covering a portion of the pivot element.

17. An apparatus as described in claim 16 further comprising:
a gasket for reducing light emission from the pushbutton.

18. An apparatus as described in claim 17 wherein said gasket and said noise reducing element are formed as a single element.
